(19) United States
(12) Patent Application Publication
(10) Pub. No.: US 2015/0117835 A1
(43) Pub. Date: Apr. 30, 2015

(54) INFORMATION PROCESSING APPARATUS, CONTROL METHOD AND PROGRAM

(71) Applicant: JVC KENWOOD Corporation, Yokohama-shi (JP)

(72) Inventor: Shu YABUUCHI, Tokyo (JP)

(21) Appl. No.: 14/520,682

(22) Filed: Oct. 22, 2014

(30) Foreign Application Priority Data
Oct. 31, 2013 (JP) 2013-227295

(51) Int. Cl. G11B 27/22; G11B 31/00; G11B 27/34; G06K 9/00

(52) U.S. Cl. CPC G11B 27/22; G06K 9/00771; G06K 9/00744; G06K 9/00342; G11B 31/006; G11B 27/34; G06K 2009/00738
USPC 386/230; 382/103

(57) ABSTRACT

An information processing apparatus according to the present invention includes a detection unit that detects a stay area where a mobile object in a target space stays longer than a predetermined time based on video data obtained by shooting the target space; and a display control unit that generates display data to display sign information at a position corresponding to the stay area in graphic data corresponding to the target space, when the graphic data is displayed.

### INCORPORATION BY REFERENCE

This application is based upon and claims the benefit of priority from Japanese patent application No. 2013-227295, filed on Oct. 31, 2013, the disclosure of which is incorporated herein in its entirety by reference.

### BACKGROUND OF THE INVENTION

1. Field of the Invention

The present invention relates to an information processing apparatus, a control method and a program.

2. Description of Related Art

A technique related to display a moving locus of a specific mobile object in a monitoring space using video data, position information, a time range within which the mobile object exists in the video data is disclosed in Japanese Unexamined Patent Application Publication No. 2008-306604. Note that the video data is obtained by shooting by using a plurality of shooting apparatuses (camera) set up at the monitoring space. Further, the position information is information which indicates a position of the mobile object detected by a position detection apparatus (IC tag reader/writer).

A technique related to record GPS (Global Positioning System) information acquired by a PND (Portable Navigation Device) mounted in a car as log data, calculate a stopping position of the car based on the log data, and display the stopping position as an icon or the like on a traveling map image is disclosed in Japanese Unexamined Patent Application Publication No. 2010-146173.

### SUMMARY OF THE INVENTION

When an illegal activity such as stealing, luggage lifting, or the like was conducted at a store etc., a person in charge of surveillance needs to reproduce a video data shot by a monitoring camera which is installed in the store etc. and confirm whether the illegal activity had been done or not by visually checking and tracking the movement of the tracking target person. Specifically, when the illegal activity was done, it was necessary to find out that the tracking target person had stood at a standstill in a specific position and precisely check the movement of the tracking target person in that position or the like. Therefore, the present inventors have found a problem that a work load for tracking is large and its efficiency is poor.

In the above-mentioned Japanese Unexamined Patent Application Publication No. 2008-306604, it is possible to detect whether the mobile object is present or not in the video data and display its moving locus in the map. However it is impossible to detect a specific stopping position or a movement in the stopping position. Further, Japanese Unexamined Patent Application Publication No. 2010-146173 uses GPS information for calculation of the stopping position. However, it is necessary to install a position information obtaining terminal beforehand. Therefore, it cannot be applied to a number of unspecified customers at the store etc.

The present invention has been made to solve the above problems and an exemplary object of the present invention is thus to provide an information processing apparatus, a control method, a program and an information system capable of increasing the efficiency of the operation for tracking a movement of a mobile object included in video data and reducing the work load.

An information processing apparatus according to one embodiment of the present invention includes a detection unit that detects a stay area where a mobile object in a target space stays longer than a predetermined time based on video data obtained by shooting the target space; and a display control unit that generates display data to display sign information at a position corresponding to the stay area in graphic data corresponding to the target space, when the graphic data is displayed.

A control method according to one embodiment of the present invention is a control method of an information processing apparatus displaying video data obtained by shooting a target space. The method includes, by the information processing apparatus, detecting a stay area where a mobile object in a target space stays longer than a predetermined time based on the video data; and generating display data to display sign information at a position corresponding to the stay area in graphic data corresponding to the target space, when the graphic data is displayed.

A program according to one embodiment of the present invention causes a computer to execute: a detection processing of detecting a stay area where a mobile object in a target space stays longer than a predetermined time based on video data obtained by shooting the target space; and a display control processing of generating display data to display sign information at a position corresponding to the stay area in graphic data corresponding to the target space, when the graphic data is displayed.

According to the exemplary aspects of the present invention, it is possible to provide an information processing apparatus, a control method and a program capable of increasing the efficiency of the operation for tracking a movement of a mobile object included in video data and reducing the work load.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing an overall configuration of an information system according to a first exemplary embodiment of the present invention;

FIG. 2 is a block diagram showing a configuration of an information processing apparatus according to the first exemplary embodiment of the present invention;

FIG. 3 is a diagram showing an example of a shot image according to the first exemplary embodiment of the present invention;

FIG. 4 is a diagram to illustrate a concept of a moving object detection process according to the first exemplary embodiment of the present invention;

FIG. 5 is a diagram showing an example of a shooting environment (upper part) according to the first exemplary embodiment of the present invention;

FIG. 6 is a diagram showing an example of a shooting environment (side) according to the first exemplary embodiment of the present invention;

FIG. 7 is a diagram showing a display example of a moving locus and a marker drawn on a map according to the first exemplary embodiment of the present invention;

FIG. 8 is a diagram showing an example of a selection of the marker according to the first exemplary embodiment of the present invention;

FIG. 9 is a diagram showing an example of a seek bar according to the first exemplary embodiment of the present invention;

FIG. 10 is a diagram showing an example of an event marker according to the first exemplary embodiment of the present invention;

FIG. 11 is a flowchart showing a flow of a video reproduce process according to the first exemplary embodiment of the present invention;

FIG. 12 is a flowchart showing a flow of a display process of the moving locus and the marker according to the first exemplary embodiment of the present invention;

FIG. 13 is a flowchart showing a flow of a display process of the moving locus and the marker according to the first exemplary embodiment of the present invention;

FIG. 14 is a block diagram showing a configuration of a computing apparatus including a detection unit and its peripheral components according to a second exemplary embodiment of the present invention; and

FIG. 15 is a block diagram showing a configuration of a computing apparatus including a display control unit and a reproduce unit, and its peripheral components according to the second exemplary embodiment of the present invention.

### DESCRIPTION OF THE EXEMPLARY EMBODIMENTS

Specific exemplary embodiments of the present invention will be described hereinafter in detail with reference to the drawings. It is noted that in the description of the drawings, the same elements will be denoted by the same reference symbols and redundant description will be omitted to clarify the explanation.

### First Exemplary Embodiment

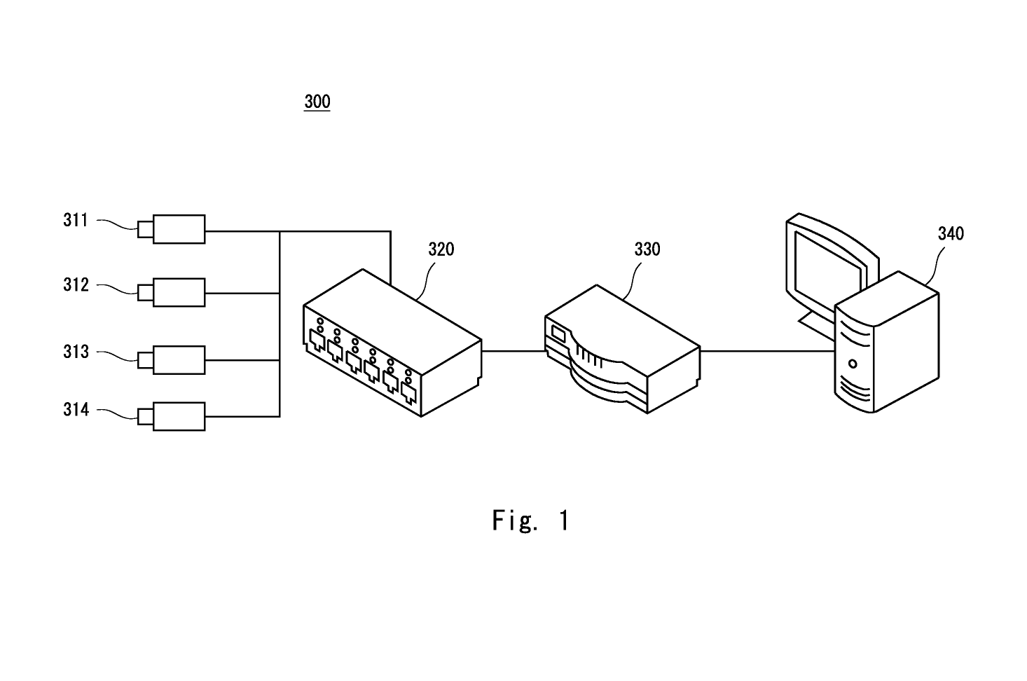

FIG. 1 is a block diagram showing an overall configuration of an information system 300 according to a first exemplary embodiment of the present invention. The information system 300 includes cameras 311 to 314, a hub 320, a recorder 330, and a monitoring PC (Personal Computer) 340. In the first exemplary embodiment of the present invention, an information system or an information processing apparatus that can specify a stay area where a mobile object such as a person, which is present in video data obtained by shooting a target space during a certain period of time by using a shooting apparatus, is present will be described. An example of the information system 300 is a monitoring system that monitors a motion of the mobile object with cameras 311 to 314. The cameras 311 to 314 are an example of the shooting apparatus. The cameras 311 to 314 shoot the target space during the certain period of time and output the obtained video data. The target space is a real space which is an object or a space shot by the shooting apparatus and, for example, is a store etc. Further, the mobile object is typically a customer of the store. However, the target space may be a space other than the store and the mobile object may be a living thing other than a person, a vehicle, a robot or the like. Note that the number of cameras may be at least one. Each camera may shoot a different area in the target space. Alternatively, a plurality of cameras may shoot a common area at different angles. Each of the cameras 311 to 314 is connected to the hub 320. The hub 320 is connected to each of the cameras 311 to 314 and to the recorder 330. The recorder 330 stores video data shot by using each of the cameras 311 to 314 into its internal storage device (not shown). The monitoring PC 340 is connected to the recorder 330, and processes the video data stored in the recorder 330. The monitoring PC 340 is an example of the information processing apparatus according to the first exemplary embodiment of the present invention. Note that the recorder 330 may be built into each of the cameras 311 to 314, or may be built into the monitoring PC 340.

[Information Processing Apparatus]

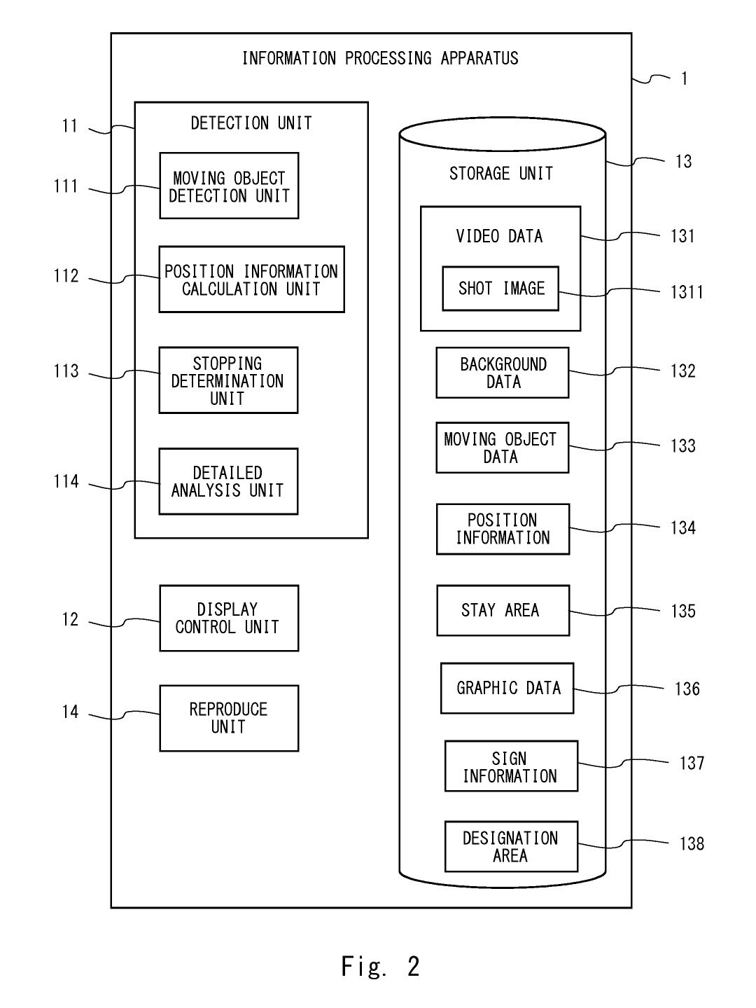

FIG. 2 is a block diagram showing a configuration of an information processing apparatus 1 according to the first exemplary embodiment of the present invention. The information processing apparatus 1 includes a detection unit 11, a display control unit 12, a storage unit 13, and a reproduce unit 14. Further, the information processing apparatus 1 is connected to an input unit and an output unit (not shown). The detection unit 11 detects a stay area 135 where the mobile object in the target space stays longer than a predetermined time based on video data 131 obtained by shooting the target space. The display control unit 12 generates display data to display sign information 137 at a position corresponding to the stay area 135 in graphic data 136 corresponding to the target space, when the graphic data 136 is displayed. It is thereby possible to increase the efficiency of the operation for tracking a movement of a mobile object included in video data and reduce the work load. Note that the component where images are displayed by the display control unit 12 is an output unit.

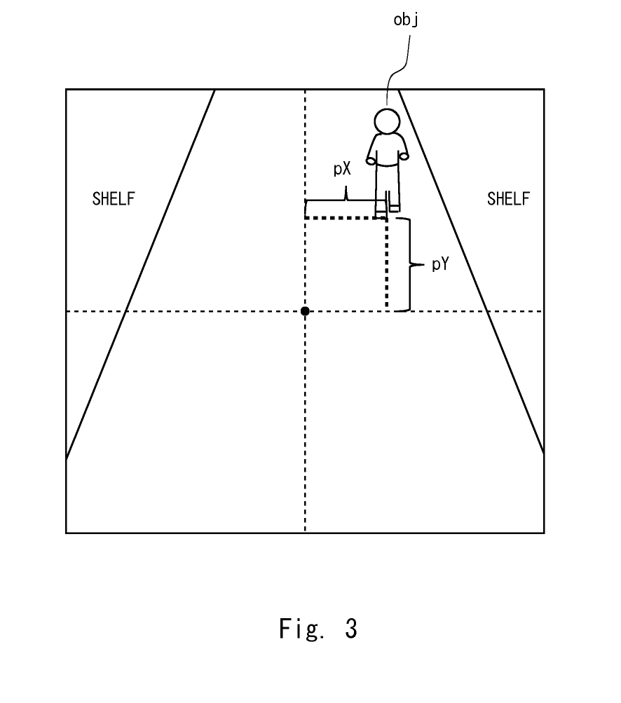

Further, the storage unit 13 is a storage device, and may be composed of a plurality of memories, hard disks or the like. The storage unit 13 stores video data 131, background data 132, moving object data 133, position information 134, stay area 135, graphic data 136, sign information 137, and a designation area 138. The video data 131 is a set of shot images 1311 which includes a plurality of frame images corresponding to shooting times at which images are shot by a shooting apparatus such as a monitoring camera (not shown). FIG. 3 is a diagram showing an example of a shot image according to the first exemplary embodiment of the present invention. The shot image shown in FIG. 3 is obtained by shooting a target area in a state where a tracking target person obj, which is an example of the mobile object, is located in a passage between rows of store shelves.

The background data 132 is image data of a background image shot in a state where the mobile object does not exist in the target space. The background data 132 may be the one that is registered in advance. Alternatively, the background data 132 may be the one that is generated by a moving object detection unit 111 described later. The moving object data 133 is image data of a difference between the shot image 1311 and the background data 132. Note that, in the following, the moving object data 133 might be called a moving object part. The position information 134 is information indicating a coordinate on the graphic data 136 described later. The stay area 135 is information indicating an area where the mobile object in the target space stays longer than a predetermined time. The graphic data 136 is data which is expressed as a figure in the target space. The graphic data 136 is typically map information such as flat data. The sign information 137 is display data which can be differentiated from other areas on the graphic data 136. The sign information 137 is an image used as a marker such as an icon, for example. The designation area 138 is an area which can designate a reproduce starting time of the video data 131 that occurs within a time period during which the mobile object stays in the stay area 135. The designation area 138 is a seek bar or the like, for example.

Specifically, the detection unit 11 includes a moving object detection unit 111, a position information calculation unit 112, a stopping determination unit 113, and a detailed analysis unit 114. The moving object detection unit 111 extracts the moving object data 133 as a difference from the background data 132, for each shot image 1311 at each shooting time in the video data 131.

[Moving Object Detection]

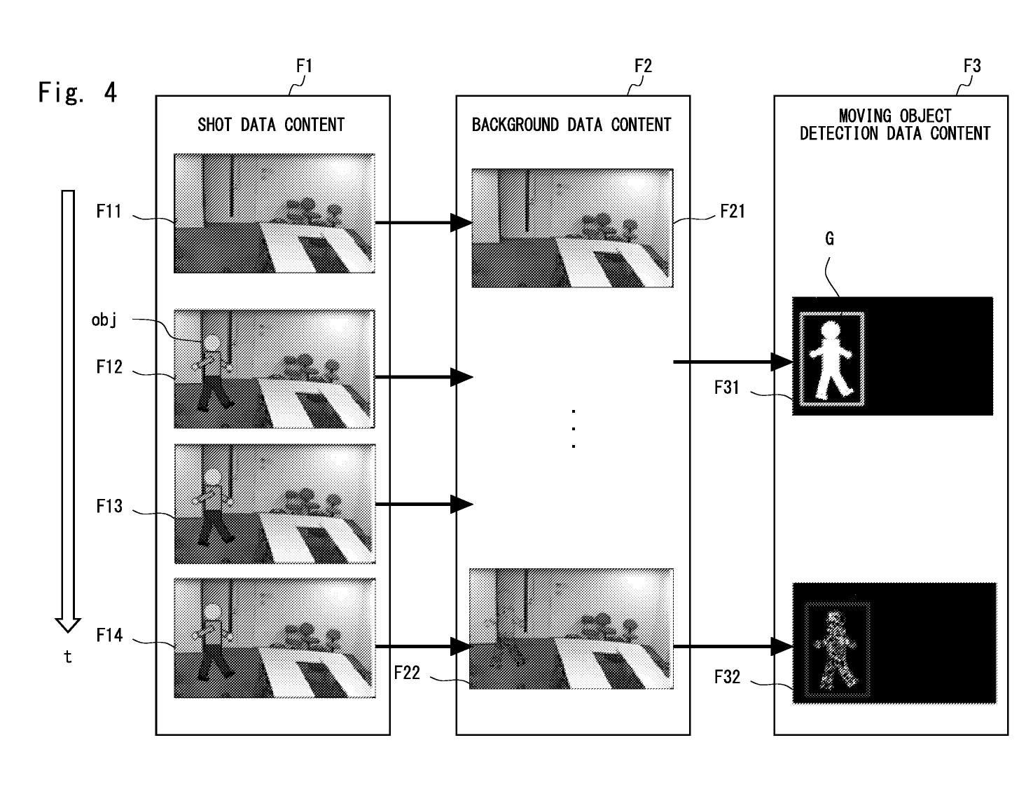

FIG. 4 is a diagram to illustrate a concept of a moving object detection process according to the first exemplary embodiment of the present invention. The moving object detection unit 111 also provides the background data 132. The shot data content F1 is an example of the video data 131. The frames F11 to F14 are an example of the shot images 1311. It is shown that the tracking target person obj entered the target space immediately after the frame F11 was shot, that the frame F12 was shot after the entrance, and that the frame F12 includes the tracking target person obj. It is shown that the frames F13 and F14 were shot after the entrance, and the frames F13 and F14 include the tracking target person obj, because the tracking target person obj stayed at the same position for a while. The frames F21 and F22 included in the background data content F2 are an example of the background data 132. The frames F31 and F32 included in the moving object detection data content F3 are an example of the moving object data 133. The moving object detection unit 111 reads the shot image 1311 from the storage unit 13 and extracts the background data 132 from the shot image 1311. For example, the moving object detection unit 111 stores the frame F21 as the background data 132 in the storage unit 13 by performing a background extracting process for the frame F11. For example, the moving object detection unit 111 is used as the frame F11 without any modification as an initial data of the background data 132 to be the frame F21. The moving object detection unit 111 stores the frame F22 as the background data 132 in the storage unit 13 by performing the background extracting process for the frame F12. For example, the moving object detection unit 111 generates the frame F22 by comparing the frame F12 with the frame F21 extracted immediately before the frame F12. Like afterward, the moving object detection unit 111 performs an update process and learning by performing the background extracting process for the frames F13 and F14, regenerates the background data 132, and stores the background data 132 in the storage unit 13.

Subsequently, the moving object detection unit 111 extracts a moving object part G using the frame F22. For example, the moving object detection unit 111 generates the frame F31 and F32 by binarizing the frame F22.

Referring to FIG. 2 again, the explanation the configuration of the information processing apparatus 1 is continued.

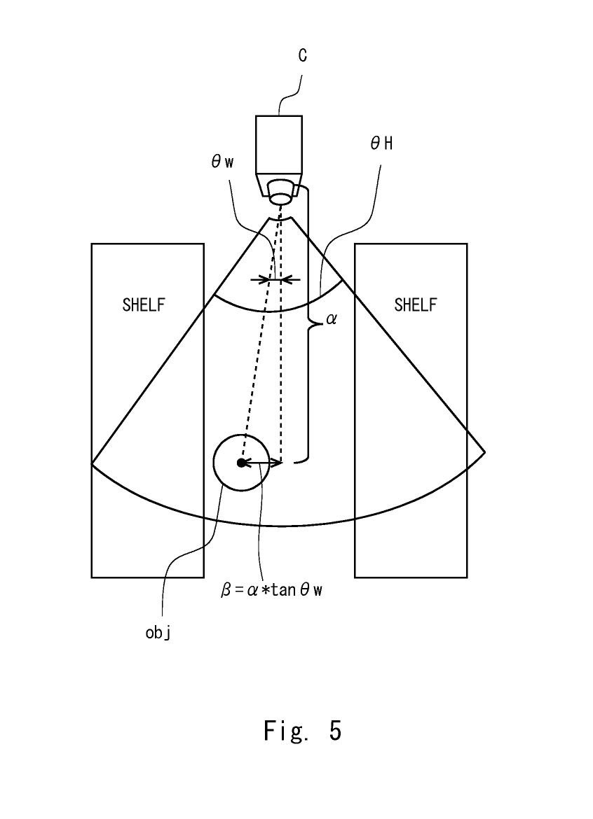

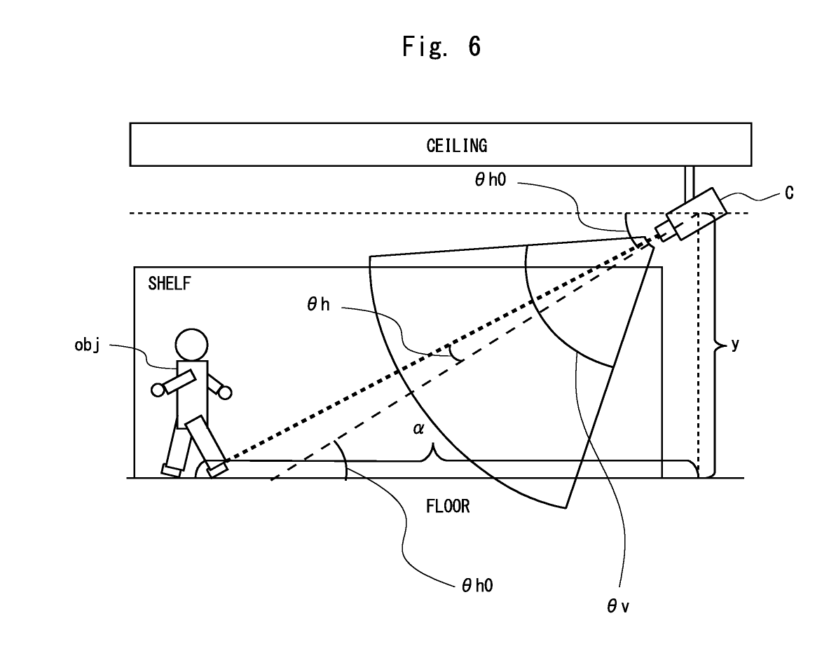

The position information calculation unit 112 calculates the position information 134 indicating a position corresponding to the moving object data 133 on the graphic data 136 using the shot image 1311 and setting information of the cameras 311 to 314 which are the shooting apparatuses. An example of the setting information of the shooting apparatus is a field angle which is an installation position of a camera, a resolution, a height of the camera, a direction or the like. The position information calculation unit 112 calculates a coordinate on the graphic data 136 corresponding to a position where the tracking target person obj exists in the shot image of FIG. 3 as the position information 134. FIG. 5 is a diagram showing an example of a shooting environment (upper part) according to the first exemplary embodiment of the present invention. FIG. 6 is a diagram showing an example of a shooting environment (side) according to the first exemplary embodiment of the present invention. It is assumed that the setting information of a camera C includes a height y of the camera C, an angle θh0 of the camera C of a vertical direction, a vertical field angle θV, a horizontal field angle θH, a vertical resolution pV, and a horizontal resolution pH. It is assumed that the position information calculation unit 112 calculates α and β of FIG. 5 as a distance between the camera C and the tracking target person obj.

First, the position information calculation unit 112 calculates pixel coordinates (pX, pY) on the shot image of FIG. 3, corresponding to a position where the tracking target person obj exists. The position information calculation unit 112 calculates a difference value in the horizontal direction of a center point on the shot image and a foot position of the tracking target person obj on the shot image as the pX. The position information calculation unit 112 calculates a difference value in the vertical direction of a center point on the shot image and a foot position of the tracking target person obj on the shot image as the pY.

Next, the position information calculation unit 112 calculates a distance α by the following formulas (1) and (2), using the above-mentioned values.

α=y*tan((90°−θh0)+θh) (1)

θh=arcsin(pY/(pV/2))*θV/π (2)

Subsequently, the position information calculation unit 112 calculates a distance β by the following formulas (3) and (4).

β=α*tan θw (3)

θw=arcsin(pX/(pH/2))*θH/π (4)

As described above, the position information calculation unit 112 can calculate the position information 134 of the tracking target person obj on the graphic data 136.

Referring to FIG. 2 again, the explanation the configuration of the information processing apparatus 1 is continued.

The stopping determination unit 113 determines whether the tracking target person obj is “walking” or “at a standstill”. Note that the “standstill” does not mean that a movement of the tracking target person obj is completely ceased in a strict meaning. The “standstill” means that the moving object data 133 exists continuously longer than a predetermined time in a prescribed area (for example, in a tracking frame in FIG. 4). That is, the “standstill” shows that the moving object data 133 stays longer than the predetermined time in the prescribed area. Therefore, the stopping determination unit 113 determines that the tracking target person obj is “standstill”, when the tracking target person obj operates to some degree in the prescribed area, but is not moving so that the tracking target person obj is considered to be walking.

In particular, first, the stopping determination unit 113 specifies a difference of the moving object data 133 between consecutive time-series shot images 1311. Further, the stopping determination unit 113 determines whether the specified difference is within the prescribed range or not. Moreover, the stopping determination unit 113 determines whether the condition that “the specified difference is within the prescribed range” continues in a prescribed number of time-series images. When the number of images through which the aforementioned state continues exceeds the prescribed number, the stopping determination unit 113 determines that the moving object part stays longer than a predetermined time in a prescribed area. That is, the stopping determination unit 113 determines that the mobile object is at a standstill. The stopping determination unit 113 detects an area including the moving object data 133 as the stay area 135. For example, the stopping determination unit 113 may determine whether number of pixels is less than threshold by generating a histogram from the number of pixels which is a difference of the moving object data 133 of a respective one of the images. Alternately, the stopping determination unit 113 may determine by using averages of movements. Note that the stopping determination unit 113 may divide the moving object data 133 into parts of body and recognize the moving object data 133 on a part-by-part basis, and set a different threshold for each part. For example, it is possible to reduce the threshold for the difference of the foot, and to increase the threshold for the difference of the arm. Alternately, the stopping determination unit 113 may determine whether the moving object part stays longer than a predetermined time in a prescribed area by paying attention to the body.

Further, the stopping determination unit 113 may determine whether “standstill” or not by specifying a difference of the position information 134 of the shot images 1311 which are mutually adjacent according to the time series, that is, moving distance, instead of specifying a difference of the moving object data 133. Moreover, the stopping determination unit 113 may determine whether the tracking target person is at a “standstill” or not using both of the difference of the moving object data 133 and the difference of the position information 134. Thus, the accuracy of the sopping determination is increased.

The display control unit 12 generates the display data to display a moving locus which is a locus through which the tracking target person obj moves on the graphic data 136 based on the position information 134, the moving object data 133, and time information at the time when the video data 131 was shot, when the graphic data 136 is displayed. Additionally, the display control unit 12 displays the sign information 137 at a position corresponding to the stay area 135 on the moving locus.

The detection unit 11 measures a time period during which the mobile object in the target space stays in the stay area 135. The display control unit 12 performs a first reprocess for the sign information 137 according to the time measured by the detection unit 11, and displays the sign information 137 to be performed the first reprocess. In other words, the display control unit 12 generates the display data while changing the sign information 137 according to the measured time. That is the display control unit 12 displays a position where the tracking target person obj stayed on the graphic data 136 by using a different mark from the moving locus. Thus, even when the mobile object has stayed at a plurality of positions on the graphic data 136, the difference of staying time can be easily identified, and the work load which the person in charge of surveillance requires to selects a reproduce position can be reduced.

For example, the first reprocess is to change a size of the sign information 137 in display. Therefore, for example, when the time during which the mobile object stays in the stay area 135 is relatively long, the display control unit 12 may enlarge a size of the marker and display the marker. Further, the display control unit 12 may change not only the size of the marker, but also a color or shape of the marker.

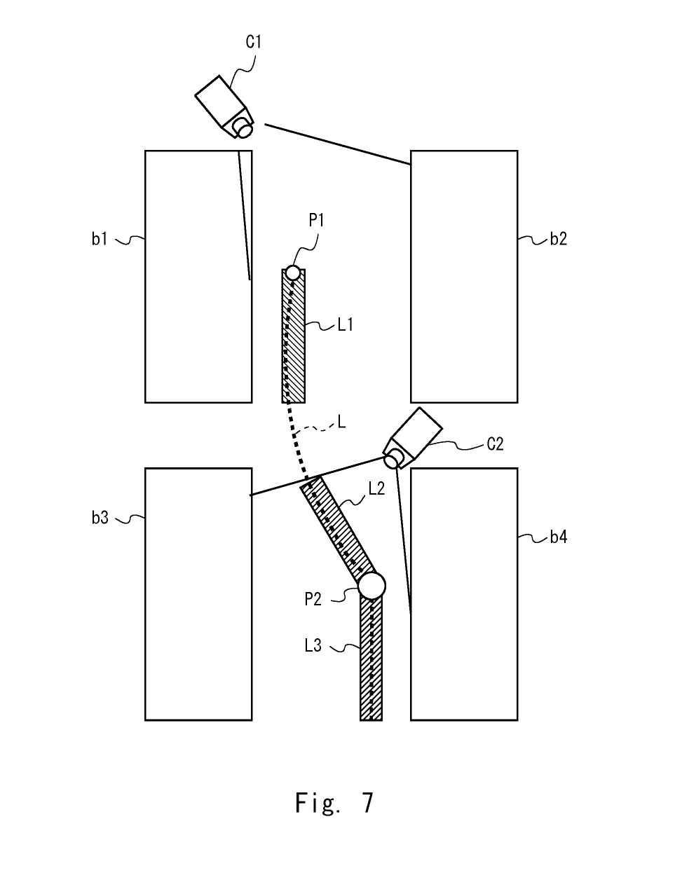

FIG. 7 is a diagram showing a display example of a moving locus and a marker drawn on a map according to the first exemplary embodiment of the present invention. In FIG. 7, a case is shown in which a camera C1 shoots a vicinity of a passage between shelves b1 and b2, and a camera C2 shoots a vicinity of a passage between shelves b3 and b4. First, the real moving locus L shows a locus which the tracking target person obj moves in fact. Note that the real moving locus L is not actually displayed on the display in the first exemplary embodiment of the present invention. The moving locus L1 is a locus of the tracking target person obj, which is derived from the video data obtained by shooting by the camera C1. The stay position P1 shows a position where the tracking target person obj stays longer than the predetermined time in the video data obtained by shooting by using the camera C1. Similarly, the moving loci L2 and L3 are loci of the tracking target person obj, which are derived from the video data obtained by shooting by the camera C2. The stay position P2 shows a position where the tracking target person obj stays longer than the predetermined time in the video data obtained by shooting by using the camera C2. Specifically, it shows that the size of the marker of the stay position P2 displayed is larger than that of the stay position P1, because the tracking target person obj stayed in the stay position P2 for a longer time than he/she stayed in the stay position P1.

Referring to FIG. 2 again, the explanation the configuration of the information processing apparatus 1 is continued.

The display control unit 12 displays the designation area 138, when the display control unit 12 receives a selection of the displayed sign information 137. The reproduce unit 14 reproduces the video data 131 from a time when the mobile object starts staying in the stay area 135 based on the selection of the sign information 137 received. In other words, the reproduce unit 14 reproduces the video data 131 corresponding to the period during which the mobile object stays in the stay area 135, when a selection operation of the sign information 137 is performed. Specifically, the reproduce unit 14 reproduces the video data 131 from a selected reproduce starting time, when the reproduce unit 14 receives a selection of the reproduce starting time for the designation area 138. That is, the display control unit 12 displays a state of the tracking target person obj and a staying time so that the user can easily view this information based on the position information 134, the moving object data 133, and time information regarding when the video data 131 was shot. When the sign information is was clicked, the display control unit 12 displays a reproduce bar limited at the staying time. It is possible to reproduce part of the video data corresponding to the period during which the tracking target person obj has stayed in the stay area 135.

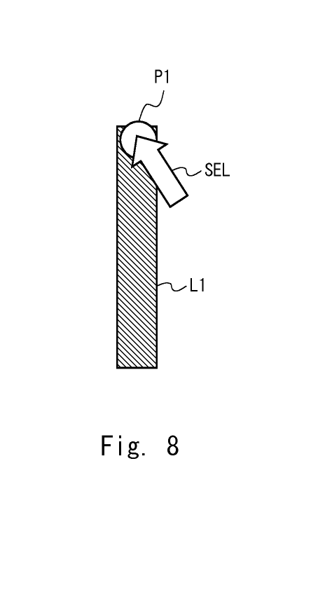

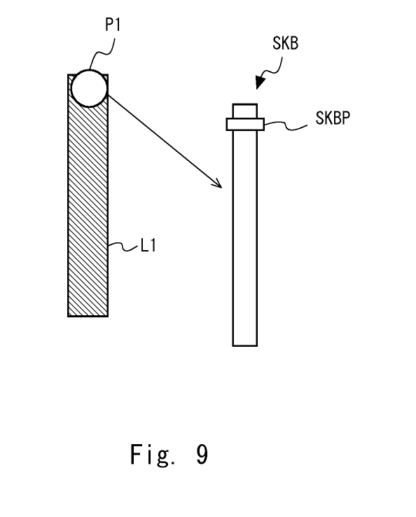

FIG. 8 is a diagram showing an example of a selection of the marker according to the first exemplary embodiment of the present invention. In FIG. 8, for example, a case is shown where to be performed selection operation SEL by a mouse operation for the stay position P1 is performed. Thus, the display control unit 12 displays a seek bar which is the designation area 138 as a range from a start time to a finish time during which the tracking target person obj stays in the stay position P1. FIG. 9 is a diagram showing an example of a seek bar SKB according to the first exemplary embodiment of the present invention. The reproduce point SKBP is a point which has been designated as the reproduce starting time.

Referring to FIG. 2 again, the explanation the configuration of the information processing apparatus 1 is continued.

After the stopping determination unit 113 detects the stay area 135, the detailed analysis unit 114 analyzes in detail between the respective moving object data 133 in a period during which the mobile object stays in the stay area 135 and detects a motion of a certain part included in the mobile object. The display control unit 12 performs a second reprocess for the sign information 137 according to the motion of the certain part detected by the detailed analysis unit 114, and displays the sign information 137 that the second reprocess is to be performed. On the other hand, the display control unit 12 generates the display data while changing the sign information 137 according to the detected motion of the certain part. Thus, when the mobile object has stayed at a plurality of positions on the graphic data 136, and especially when the staying times of the plurality of positions are the same as each other, the motion which has a higher possibility which is an illegal activity can be easily identified, and the work load for which the person in charge of surveillance selects a reproduce position can be reduced.

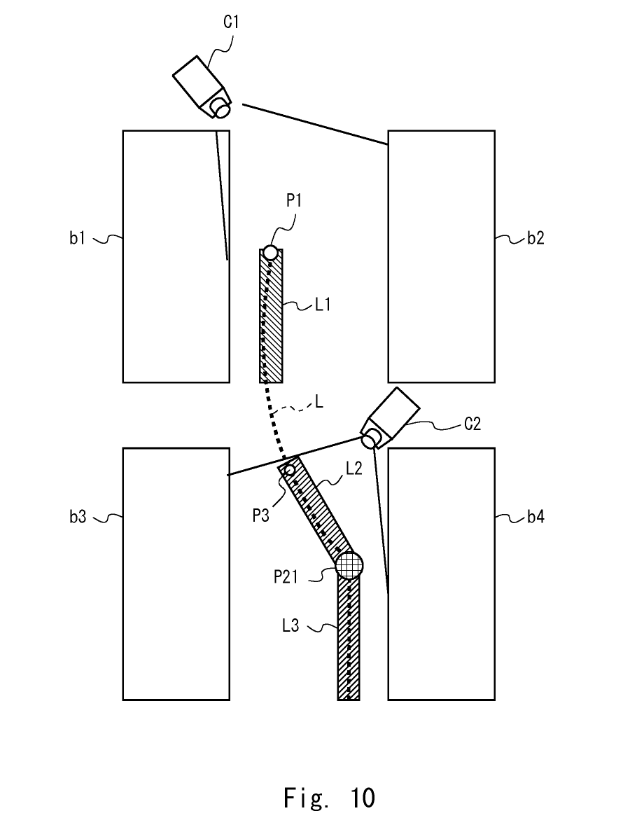

For example, the second reprocess is to change a type of the sign information 137. Therefore, while the mobile object stays in the stay area 135, such as when the mobile object moves his/her hand or when the mobile object moves his/her own neck as if he/she is looking for the camera, the display control unit 12 may change a type of the marker to one which attracts more attention, and displays the marker. FIG. 10 is a diagram showing an example of an event marker according to the first exemplary embodiment of the present invention. For example, when the tracking target person obj stays a predetermined time in the stay position P21 and moves his/her hand, the display control unit 12 displays an event marker shown in the stay position P21.

Moreover, when the detection unit 11 can determine whether it occurs an occlusion (a person overlaps mutually) using a technique such as a person detection, the display control unit 12 may display the occlusion as the sign information 137.

As described above, it becomes possible for the person in charge of surveillance to soon find the mobile object who is may have done an illegal activity and then to confirm if an illegal activity has actually been done by this mobile object, because the display control unit 12 displays various types of the sign information 137 in the position corresponding to the stay area 135 on the graphic data 136, and receives the selection operation of the sign information 137.

An example of a use form of the information system 300 according to a first exemplary embodiment of the present invention will now be explained. For example, it is assumed that the target space is a store where commodities are displayed on a store shelf. Further, it is assumed that it is recognized that a commodity of a certain store shelf is gone without being paid for. In this case, it is necessary to track the person who possibly may have done this illegal activity and to confirm whether this illegal activity has actually been done or not by this person by reproducing the video data obtained by shooting by using the cameras 311 to 314 which are installed in respective places in the store.

At this time, many customers are present in the video data. Therefore, if the person in charge of surveillance reproduces the video data of the entire time period and finds out that illegal activities have been done, a work load of the person in charge of surveillance would become large and thus his/her efficiency would become poor. Further, when an illegal activity is being performed, there is a high possibility that the doer of the illegal activity will stop longer than a predetermined time in the vicinity of the store shelf to pretend to shop around before actually performing the illegal activity. Therefore, in the exemplary embodiment of the present invention, the person in charge of surveillance can confirm whether an illegal activity had been done or not by clicking the marker etc., when the marker etc. is displayed on the target store shelf as a result of the stay area being detected from the video data, and displaying the stay position on the graphic data.

In another case, when a repeat offender of the illegal activity was detected, the person in charge of surveillance reproduces the video data and tracks the activity of the repeat offender in the video data. In this case, if the person in charge of surveillance reproduces the video data of the entire time period, this task would be troublesome. Further, the work load of the person in charge of surveillance would become large and thus his/her efficiency would become poor. Therefore, in the exemplary embodiment of the present invention, it is possible to realize effective tracking by narrowing down a period of time the repeat offender stops longer than a predetermined time in the video data and reproducing the video data in the period of time. Note that a use form of the information system 300 according to a first exemplary embodiment of the present invention is not limited thereto.

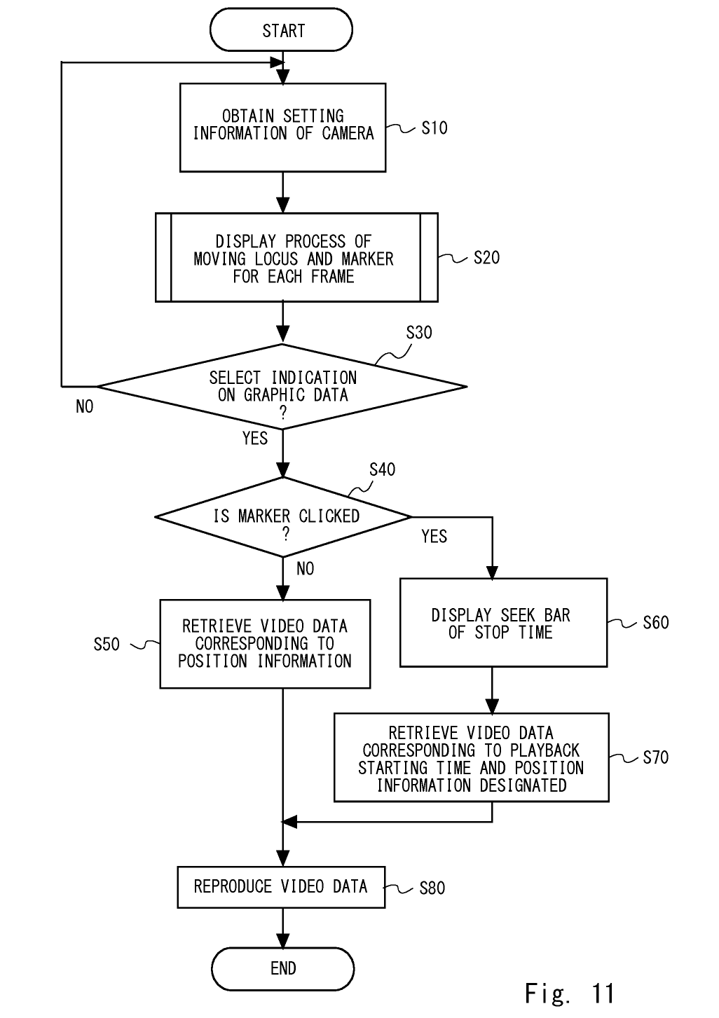

FIG. 11 is a flowchart showing a flow of a video reproduce process according to the first exemplary embodiment of the present invention. First, the information processing apparatus 1 obtains setting information of the camera which is the shooting apparatus (S10). That is, the information processing apparatus 1 obtains the setting information to set the camera 311 etc. and stores the setting information in the storage unit 13. Note that the setting information of each camera is omitted, as shown in the mentioned above.

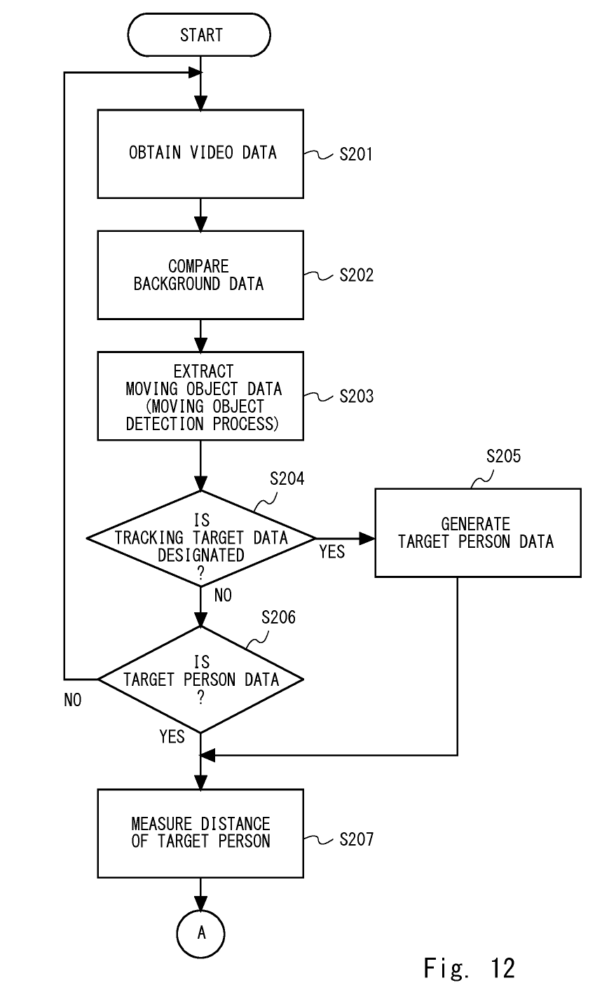

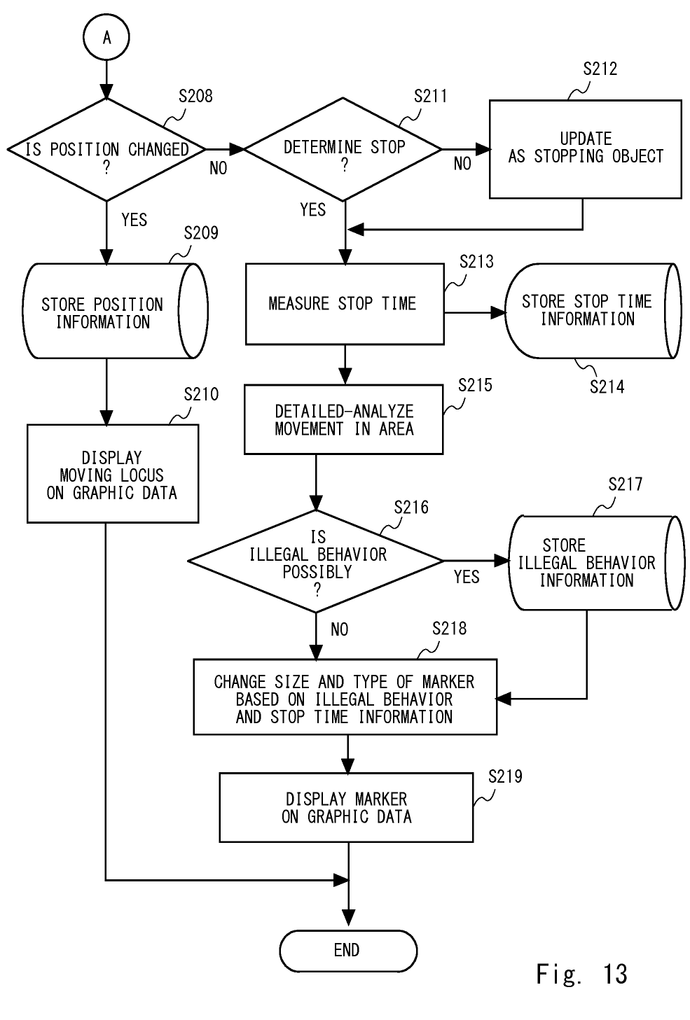

Next, the information processing apparatus 1 performs a display process of the moving locus and the marker for each frame (S20). FIGS. 12 and 13 are flowcharts showing a flow of a display process of the moving locus and the marker according to the first exemplary embodiment of the present invention. First, the moving object detection unit 111 obtains the video data 131 from the storage unit 13 (S201). Next, the moving object detection unit 111 compares the shot images 1311 with the respective background data 132 (S202), respectively. The moving object detection unit 111 then extracts the moving object data 133 from the result of the comparison with the background data 132 (moving object detection process) (S203).

After that, the detection unit 11 determines whether tracking target data is designated or not (S204). For example, when the display control unit 12 outputs the moving object data 133 as a candidate of tracking target data, and receives a selection of any of the moving object data 133, the detection unit 11 determines that tracking target data is designated.

When the detection unit 11 determines that tracking target data is designated in the step S204, the detection unit 11 generates target person data (S205). The target person data shows color information and shape information etc. of the tracking target person (or a tracking target object). The color information is generated by using values of RGB components and HSV (color phase, intensity, and brightness) components with color data. For example, the color information can be generated by determining a representative color etc. and creating a histogram and the like. The shape information is generated by extracting edge information in the display from a luminance gradient.

By contrast, in the step S204, when the detection unit 11 determines that tracking target data is not designated, the detection unit 11 determines whether the target person data has been generated or not (S206). When the target person data has not been generated, the process returns to the step S201.

When the detection unit 11 determines that the target person data has been generated in the step S206 or after the step S205, the position information calculation unit 112 measures a distance of the target person (S207). For example, the position information calculation unit 112 measures the distance by using the above-mentioned method for calculating the position information. At this time, the position information calculation unit 112 uses the setting information obtained in the step S10.

Subsequently, the stopping determination unit 113 determines whether there is a change in the position of the target person or not (S208). That is, the stopping determination unit 113 compares a position information of a time immediately before the present time and a current position information, and determines whether a difference is in a prescribed range or not. When the stopping determination unit 113 determines that there is a change in a position of the target person, the stopping determination unit 113 stores the position information 134 in the storage unit 13 (S209). The display control unit 12 then displays the moving locus on the graphic data 136 based on the position information 134 (S210).

By contrast, in the step S208, when the stopping determination unit 113 determines that there is not a change in a position of the target person, the stopping determination unit 113 determines whether the target person has stopped or not (S211). Note that the definition of “standstill” and a method for determining it are mentioned above.

When the stopping determination unit 113 determines that the target person has not stopped in the step S211, the stopping determination unit 113 updates the above designated target data as a stopping object (S212).

When the stopping determination unit 113 determines that the target person has stopped in the step S211 or after the step S212, the stopping determination unit 113 measures a stop time (stay time) information by increasing the number of frames during the stop time (S213). Subsequently, the stopping determination unit 113 stores the measured stop time information in the storage unit 13 (S214).

Further, the detailed analysis unit 114 analyzes in detail a motion of the moving object data 133 in the above-mentioned stay area 135 (S215). The detailed analysis unit 114 determines whether it is possible that an illegal behavior has occurred carried out or not (S216). When the detailed analysis unit 114 determines that it is possible that an illegal behavior has occurred, the detailed analysis unit 114 stores the result as illegal behavior information (S217). When the detailed analysis unit 114 determines that it is possible/it is not possible that an illegal behavior has occurred after the step S217, the detailed analysis unit 114 changes a size and a type of the marker based on the determination result of the step S216 and the stop time information (S218). That is, the detailed analysis unit 114 refers to the storage unit 13, and changes the size and the type of the marker according to an illegal behavior information and the stop time information.

After that, the display control unit 12 displays the changed marker in the position corresponding to the stay area on the graphic data 136 (S219).

Referring to FIG. 11 again, the explanation of the flow of a video reproduce process is continued.

After the step S20, the display control unit 12 determines whether an indication on the graphic data 136 is selected or not (S30). When the indication is not selected, the process returns to the step S10. When the indication is selected, the display control unit 12 determines whether the marker is selected or not (S40). When the marker is not selected, that is, the moving locus is selected, the reproduce unit 14 retrieves the video data corresponding to the selected position information (S50). In contrast, in the step S40, when the marker is selected, the display control unit 12 displays a seek bar of a length of the stop time corresponding to the selected marker (S60). The reproduce unit 14 then retrieves the video data corresponding to a reproduce starting time and the designated position information for the seek bar (S70). After the step S50 or S70, the reproduce unit 14 reproduces the retrieved video data (S80).

From the above-mentioned, it is the following effect in the first exemplary embodiment of the present invention. First, it becomes possible to select immediately an activity of a tracking target person which the person in charge of surveillance would like to confirm whether it is illegal or not. Further, there is no need to reproduce an unnecessary video part by displaying the seek bar in the stopping position. Moreover, it is possible for the person in charge of surveillance to obtain the position information on where the tracking target person is, even if the tracking target person does not have the position information obtaining terminal beforehand. Further, this embodiment can display the state of the tracking target person and his/her staying time so that the person in charge of surveillance can easily view the information by storing the position information and the stopping position and changing the marker on the map according to the stop time. Furthermore, this embodiment can display an activity of the tracking target person so that the person in charge of surveillance can easily view the information simply by changing the marker in accordance with the activity of the tracking target person. It can retrieve a user who stays in a specific area for a long time by using the stopping position and the stop time database. Further, it can promptly find a position where the target person has stayed by determining a stopping state from a video input and adding the stop time on the map.

### Second Exemplary Embodiment

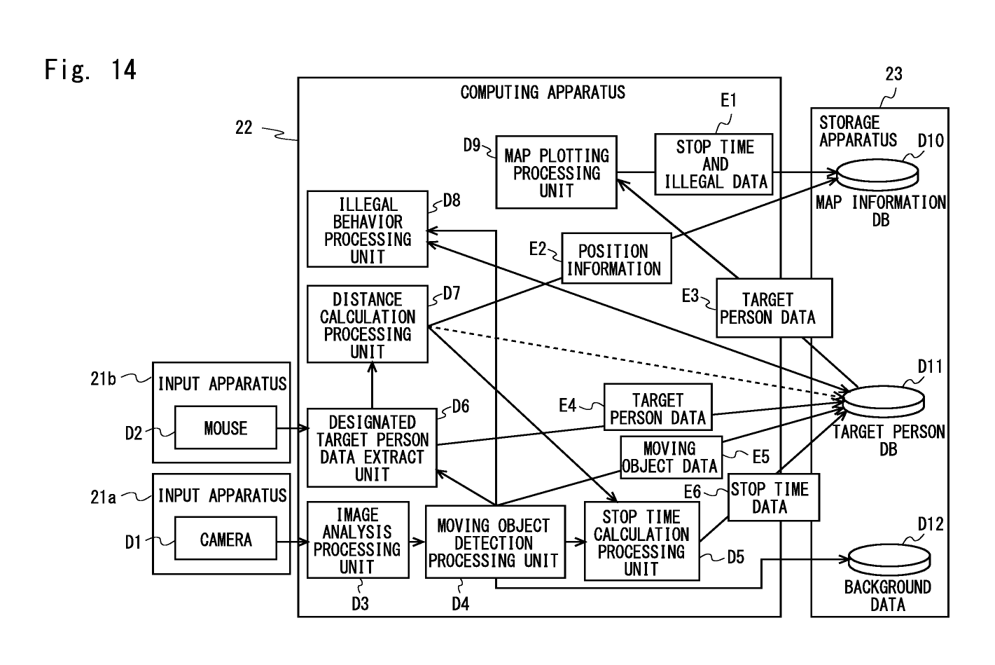

In the second exemplary embodiment of the present invention, the above-mentioned detection unit 11, display control unit 12, and reproduce unit 14 are implemented in an independent configuration. FIG. 14 is a block diagram showing a configuration of a computing apparatus including a detection unit and its peripheral components according to the second exemplary embodiment of the present invention. FIG. 14 shows input apparatuses 21a and 21b, a computing apparatus 22, and a storage apparatus 23. Note that a physical composition is not limited thereto.

The input apparatus 21a includes a camera D1. It can be said that the camera D1 is a camera video obtain unit. The camera D1 obtains image data for each shooting time using a sensor. The camera D1 outputs the obtained image data to an image analysis processing unit D3 to be described.

The input apparatus 21b includes a mouse D2. It can be said that the mouse D2 is a display coordinate designation obtain unit. The mouse D2 clicks on a video display unit (not shown) connected to the computing apparatus 22, and outputs the coordinate data to a designated target person data extract unit D6.

The computing apparatus 22 includes an image analysis processing unit D3, a moving object detection processing unit D4, a stop time calculation processing unit D5, a designated target person data extract unit D6, a distance calculation processing unit D7, an illegal behavior processing unit D8, and a map plotting processing unit D9.

The image analysis processing unit D3 performs resizing or color-transforming process of the video data received from the camera D1, and outputs the transformed video data to be processed to the moving object detection processing unit D4.

The moving object detection processing unit D4 generates the background data from the transformed video data received from the image analysis processing unit D3, and stores the background data in the storage apparatus 23. Further, the moving object detection processing unit D4 performs the moving object detection process and stores a moving object data E5 in a target person DB D11, as well as the above-mentioned moving object detection unit 111.

The stop time calculation processing unit D5 measures a stop time of a target object or a target person based on a moving object data from the moving object detection unit 111, position information from the distance calculation processing unit D7 and the like, as well as the above-mentioned stopping determination unit 113. The stopping determination unit 113 stores the measured stop time data E6 in the target person DB D11.

The designated target person data extract unit D6 extracts the target person data (color information or shape information) by using the coordinate data received from the mouse D2, the moving object data obtained from the moving object detection processing unit D4, and an object mapping process. The designated target person data extract unit D6 stores the extracted target data in the target person DB D11.

The distance calculation processing unit D7 calculates the position information of the designated target person data. The distance calculation processing unit D7 stores the position information E2 which is a calculation result in a map information DB D10. Additionally, the distance calculation processing unit D7 stores the position information E2 in the target person DB D11.

The illegal behavior processing unit D8 accesses the target person DB D11, and analyzes in detail a motion of the designated target person in the stay area which is an area where the designated target person has stopped. That is, the illegal behavior processing unit D8 calculates a difference of the motion based on the moving object data obtained from the moving object detection processing unit D4, and determines whether a motion is a characteristic motion or not. The illegal behavior processing unit D8 updates the target person DB D11 according to the result of the determination as to whether a behavior is illegal or not.

The map plotting processing unit D9 plots the marker in the position on the map corresponding to the stay area detected from the video data. The map plotting processing unit D9 writes a designation of a color or a size of the marker which is plotted in the map from the stop time and illegal data E1 in the map information DB D10 based on the target person data E3 from the target person DB D11.

The storage apparatus 23 includes the map information DB D10, the target person DB D11, and the background data D12. The map information DB D10 is an example of the above-mentioned graphic data 136. The map information DB D10 is data which it is necessary to draw in the map. The target person DB D11 is an example of the above-mentioned target person data. The target person DB D11 is a characteristic data of the target person or the target object. The background data D12 is an example of the above-mentioned background data 132. The background data D12 is a background data used for the moving object detection process.

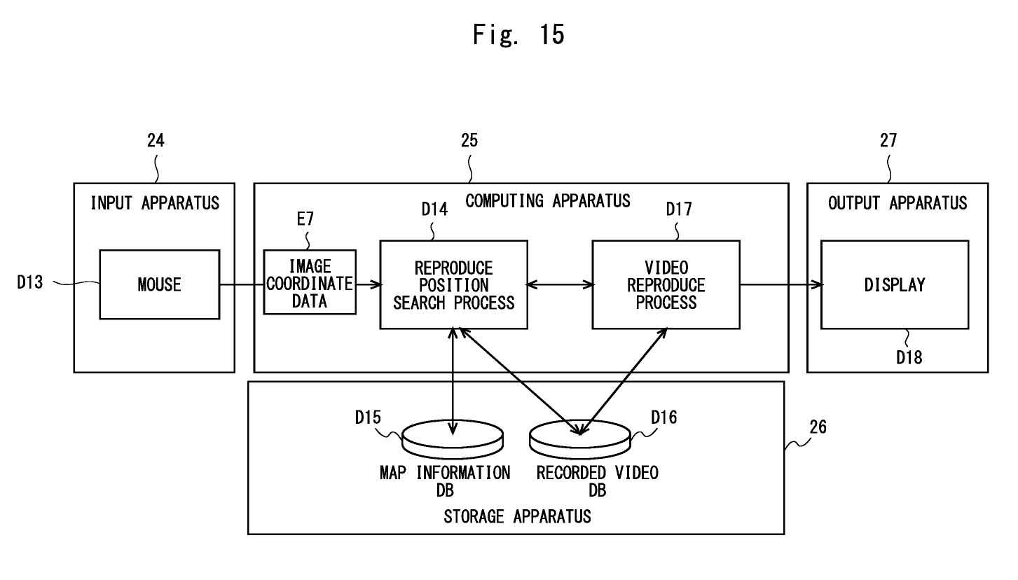

FIG. 15 is a block diagram showing a configuration of a computing apparatus including a display control unit and a reproduce unit, and its peripheral components according to the second exemplary embodiment of the present invention. FIG. 15 shows an input apparatus 24, a computing apparatus 25, a storage apparatus 26, and an output apparatus 27. Note that a physical composition is not limited thereto.

The input apparatus 24 includes a mouse D13. It can be said that the mouse D13 is a display coordinate designation obtain unit. The mouse D13 clicks on a map data displayed in the output apparatus 27, and then the image coordinate data E7 is output to a reproduce position search process D14.

The reproduce position search process D14 determines a retrieving time based on the position information of the map information DB D15, time information and an illegal data, and retrieves a reproduce position from a recorded video DB D16. Thus, the reproduce position search process D14 determines the reproduce position.

The storage apparatus 26 includes the map information DB D15 and the recorded video DB D16. The map information DB D15 is similar to the map information DB D10. The recorded video DB D16 is recorded in the video data obtained by shooting by using the camera D1.

The video reproduce process D17 accesses the recorded video DB D16 and obtains the video data based on the position information of the video data designated from the reproduce position search process D14. The video reproduce process D17 outputs the obtained video data to a display D18 and makes the display D18 display the video data.

The output apparatus 27 includes the display D18. The output apparatus 27 displays the video data received from the video reproduce process D17.

Therefore, the information system according to the second exemplary embodiment of the present invention can be expressed as follows. That is, the information system includes a storage unit, a detection unit, a display control unit, and a display unit. The storage unit stores video data obtained by shooting a target space by using a shooting apparatus. The detection unit detects a stay area where a mobile object in the target space stays longer than a predetermined time based on the video data stored in the storage unit. The display control unit generates display data to display sign information at a position corresponding to the stay area in graphic data corresponding to the target space, when the graphic data is displayed. The display unit displays the display data generated by the display control unit. As described above, it can provide an effect similar to the first exemplary embodiment according to the constitution of the second exemplary embodiment of the present invention.

### Other Exemplary Embodiments

According to the present invention, any processing of the above-mentioned shooting apparatus and the mobile terminal apparatus can be implemented by causing a CPU (Central Processing Unit) to execute a computer program. In this case, the computer program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

Further, in addition to the cases where the functions of the above-described exemplary embodiment are implemented by causing a compute to execute a program that is used to implement functions of the above-described exemplary embodiment, other cases where the functions of the above-described exemplary embodiment are implemented by this program with the cooperation with the OS (Operating System) or application software running on the computer are also included in the exemplary embodiment of the present invention. Further, other cases where all or part of the processes of this program are executed by a function enhancement board inserted into the computer or a function enhancement unit connected to the compute and the functions of the above-described exemplary embodiment are thereby implemented are also included in the exemplary embodiment of the present invention.

Note that the above-mentioned first or second exemplary embodiment may include the following constitution.

(Supplementary Note 1)

The display control unit displays a designation area for which a reproduce starting time of the video data can be designated within a time period during which the mobile object stays in the stay area when the selection operation of the displayed sign information is performed;

the reproduce unit reproduces the video data from the selected reproduce starting time, when the selection operation of the reproduce starting time for the designation area is performed.

(Supplementary Note 2)

The detection unit extracts a moving object part which is a difference from a background image shot in a state where the mobile object does not exist in the target space for an image at each shooting time in the video data, and detects an area including the moving object part as the stay area, when a condition that a difference of the moving object part between convective time-series images is within a predetermined range continues over a predetermined number of time-series images.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An information processing apparatus comprising:
a detection unit that detects a stay area where a mobile object in a target space stays longer than a predetermined time based on video data obtained by shooting the target space; and
a display control unit that generates display data to display sign information at a position corresponding to the stay area in graphic data corresponding to the target space, when the graphic data is displayed.

2. The information processing apparatus according to claim 1, wherein
the detection unit measures a time during which the mobile object in the target space stays in the stay area; and
the display control unit generates the display data while changing the sign information according to the measured time.

3. The information processing apparatus according to claim 1, wherein
the detection unit detects a motion of a certain part included in the mobile object in a period during which the mobile object stays in the stay area after the detection unit detects the stay area; and
the display control unit generates the display data while changing the sign information according to the motion to be detected.

4. The information processing apparatus according to claim 2, wherein
the detection unit detects a motion of a certain part included in the mobile object in a period during which the mobile object stays in the stay area after the detection unit detects the stay area; and
the display control unit generates the display data while changing the sign information according to the motion to be detected.

5. The information processing apparatus according to claim 1, further comprising:
a reproduce unit that reproduces the video data corresponding to the period during which the mobile object stays in the stay area, when a selection operation of the displayed sign information is performed.

6. The information processing apparatus according to claim 2, further comprising:
a reproduce unit that reproduces the video data corresponding to the period during which the mobile object stays in the stay area, when a selection operation of the displayed sign information is performed.

7. The information processing apparatus according to claim 3, further comprising:
a reproduce unit that reproduces the video data corresponding to the period during which the mobile object stays in the stay area, when a selection operation of the displayed sign information is performed.

8. The information processing apparatus according to claim 4, further comprising:
a reproduce unit that reproduces the video data corresponding to the period during which the mobile object stays in the stay area, when a selection operation of the displayed sign information is performed.

9. A control method of an information processing apparatus displaying video data obtained by shooting a target space, the method comprising:
by the information processing apparatus,
detecting a stay area where a mobile object in a target space stays longer than a predetermined time based on the video data; and
generating display data to display sign information at a position corresponding to the stay area in graphic data corresponding to the target space, when the graphic data is displayed.

10. A non-transitory computer readable medium storing a program causing a computer to execute:
a detection processing of detecting a stay area where a mobile object in a target space stays longer than a predetermined time based on video data obtained by shooting the target space; and
a display control processing of generating display data to display sign information at a position corresponding to the stay area in graphic data corresponding to the target space, when the graphic data is displayed.
